(19) United States
(12) Patent Application Publication
(10) Pub. No.: US 2024/0340078 A1
(43) Pub. Date: Oct. 10, 2024

(54) Artificial Satellite System and Method for Measuring Distance Between Artificial Satellites

(71) Applicant: Hitachi, Ltd., Tokyo (JP)

(72) Inventors: Hisatoshi KIMURA, Tokyo (JP); Tsukasa FUNANE, Tokyo (JP); Yosuke TANABE, Tokyo (JP); Makoto ITO, Tokyo (JP); Koichi WATANABE, Tokyo (JP)

(21) Appl. No.: 18/596,139

(22) Filed: Mar. 5, 2024

(30) Foreign Application Priority Data
Apr. 5, 2023 (JP) 2023-061559

(51) Int. Cl. H04B 7/185; B64G 1/40; H04W 64/00

(52) U.S. Cl. CPC H04B 7/18521; B64G 1/40; H04B 7/18526; H04W 64/006

(57) ABSTRACT

An artificial satellite system according to the present invention includes first and second artificial satellites. An antenna of the first satellite transmits a radio wave (transmission signal) to the second satellite. An antenna of the second satellite receives the transmission signal. A software defined radio of the second satellite generates a signal having the same frequency and phase as the transmission signal has. The antenna of the second satellite transmits a radio wave of a signal generated by the second satellite to the first satellite. The antenna of the first satellite receives the radio wave (reception signal) transmitted by the second satellite. A data processing device of the first satellite determines a relative distance between the first and second satellites by using the difference between a transmission time of the transmission signal and a reception time of the reception signal and the phase difference between the transmission and reception signals.

### CLAIM OF PRIORITY

The present application claims priority from Japanese Patent Application JP 2023-061559 filed on Apr. 5, 2023, the content of which is hereby incorporated by reference into this application.

### BACKGROUND OF THE INVENTION

The present invention relates to an artificial satellite system having a plurality of artificial satellites, and a method for measuring the distance between the artificial satellites.

Constellation which combines multiple artificial satellites to function integrally has been progressing. In order to combine multiple artificial satellites, it is important to measure the position of each artificial satellite and grasp the shape of an artificial satellite group. The measurement of the position of the artificial satellite may be performed using an GNSS (Global Navigation Satellite System) such as a GPS (Global Positioning System), but depending on the position of the artificial satellite, the artificial satellite may not be able to receive signals from the GNSS. It is expected that the utilization range of small artificial satellites will expand in the future. It is becoming necessary to establish a technology of measuring the positions of multiple artificial satellites and the distance between artificial satellites even if the GNSS is not available.

An example of a conventional technology of measuring the positions of multiple artificial satellites (space crafts) has been described in document JP 2015-155897. In the technology described in the document JP 2015-155897, a host ship continuously transmits a wireless frequency signal through three antennas, and a companion ship continuously receives the signals transmitted from the host ship. The companion ship is equipped with a measuring device which measures a propagation time of each reception signal generated from each of the three antennas of the host ship and derives a path difference between a path through which the signal generated from the main antenna propagates and a path through which the signal generated from each of the two sub-antennas propagates. The host ship is equipped with a processing device which determines a relative angular position between the host ship and the companion ship from the result of measurement of the path difference transmitted from the companion ship.

As described above, there has been disclosed in the document JP 2015-155897, the technology of measuring the relative positions and distances of multiple artificial satellites (space crafts) using the propagation time difference (path difference) of the radio waves between the host ship and the companion ship. In the conventional technologies such as the technology described in the document JP 2015-155897, in order to measure mutual distances between multiple artificial satellites, there is a need to synchronize the time between the artificial satellites. In order to perform this time synchronization, a time synchronizing device or system such as an atomic clock is required. For this reason, the conventional technologies are accompanied by a problem that the cost is increased because the device becomes complicated and large, and the processing executed by the device becomes complicated.

### SUMMARY OF THE INVENTION

An object of the present invention is to provide a system and method capable of measuring relative distances between a plurality of artificial satellites without time synchronization.

An artificial satellite system of the present invention includes a plurality of artificial satellites including at least a first artificial satellite and a second artificial satellite. Each of the artificial satellites includes a data processing device, a software defined radio, and an antenna. The antenna of the first artificial satellite transmits a radio wave to the second artificial satellite as a transmission signal. The antenna of the second artificial satellite receives the transmission signal. The software defined radio of the second artificial satellite generates a signal having a same frequency and phase as the transmission signal. The antenna of the second artificial satellite transmits a radio wave of the signal generated by the software defined radio of the second artificial satellite to the first artificial satellite. The antenna of the first artificial satellite receives the radio wave transmitted by the second artificial satellite as a reception signal. The data processing device of the first artificial satellite determines a relative distance between the first artificial satellite and the second artificial satellite by using a difference between a transmission time of the transmission signal and a reception time of the reception signal and a phase difference between the transmission signal and the reception signal.

A method for measuring a distance between artificial satellites of the present invention includes the steps of: allowing a first artificial satellite to transmit a radio wave to a second artificial satellite as a transmission signal; allowing the second artificial satellite to receive the transmission signal; allowing the second artificial satellite to generate a signal having a same frequency and phase as the transmission signal; allowing the second artificial satellite to transmit a radio wave of the signal generated by the second artificial satellite to the first artificial satellite; allowing the first artificial satellite to receive the radio wave transmitted by the second artificial satellite as a reception signal; and allowing the first artificial satellite to determine a relative distance between the first artificial satellite and the second artificial satellite by using a difference between a transmission time of the transmission signal and a reception time of the reception signal and a phase difference between the transmission signal and the reception signal.

### ADVANTAGEOUS EFFECTS OF INVENTION

According to the present invention, it is possible to provide a system and method capable of measuring relative distances between a plurality of artificial satellites without time synchronization.

### BRIEF DESCRIPTION OF THE DRAWINGS

FIG. 1A is a diagram showing an example of a plurality of artificial satellites (two artificial satellites) included in an artificial satellite system according to a first embodiment of the present invention;

FIG. 1B is a diagram showing an example of a plurality of artificial satellites (four artificial satellites) included in the artificial satellite system according to the first embodiment of the present invention;

FIG. 2 is a block diagram showing an example of a schematic configuration of the artificial satellite system according to the first embodiment;

FIG. 3 is a diagram showing in more detail an example of basic configurations of a transmitting artificial satellite and a receiving artificial satellite;

FIG. 4 is a diagram showing an example of sequence control when measuring a relative distance between the transmitting artificial satellite and the receiving artificial satellite by mutually switching between the transmitting artificial satellite and the receiving artificial satellite;

FIG. 5 is a diagram showing an example of sequence control of the artificial satellite system according to the first embodiment;

FIG. 6A is a diagram for describing a frequency filter function;

FIG. 6B is a diagram for describing a frequency filter function which adjusts the frequency of a signal generated by a local oscillator;

FIG. 7 is a diagram showing an example of a flowchart of a method for measuring the distance between the artificial satellites, according to the first embodiment;

FIG. 8 is a diagram showing an example of a flowchart of sequence control which controls the speed of an artificial satellite in a second embodiment of the present invention;

FIG. 9 is a diagram showing an example of a configuration for measuring an absolute position of an artificial satellite in a third embodiment of the present invention;

FIG. 10 is a block diagram showing an example of a schematic configuration of a software defined radio in a fourth embodiment of the present invention; and

FIG. 11 is a diagram showing an example of an artificial satellite group constituted of a plurality of artificial satellites.

### DETAILED DESCRIPTION OF THE PREFERRED EMBODIMENTS

A method for measuring the distance between an artificial satellite system according to the present invention and an artificial satellite is able to measure relative distances between one artificial satellite and one or more artificial satellites without time synchronization between these artificial satellites. Therefore, it is possible to reduce devices and functions required for time synchronization and reduce the cost of constructing the artificial satellite system.

In the artificial satellite system according to the present invention, a first artificial satellite being a transmitting artificial satellite transmits a radio wave to a second artificial satellite being a receiving artificial satellite. The second artificial satellite transmits a radio wave having the same frequency and phase as the radio wave received from the first artificial satellite to the first artificial satellite. The first artificial satellite determines a relative distance between the first artificial satellite and the second artificial satellite. Further, the first artificial satellite and the second artificial satellite have the same configuration with each other. By being equipped with software defined radios, the first artificial satellite and the second artificial satellite can have both the functions as the first artificial satellite and the second artificial satellite.

The second artificial satellite preferably includes a frequency filter function which allows a radio wave in a frequency band assigned to itself among received radio waves to pass therethrough. The second artificial satellite can transmit a radio wave having the same frequency and phase as the radio wave passed by the frequency filter function to the first artificial satellite. This frequency filter function allows the artificial satellite system according to the present invention to simultaneously determine the relative distances among three or more artificial satellites.

An artificial satellite system according to an embodiment of the present invention and a method for measuring the distance between artificial satellites will hereinafter be described with reference to the drawings. Note that in the drawings used in the present specification, the same or corresponding components are given the same reference numerals, and their repetitive description may be omitted.

### First Embodiment

A description will be made about an artificial satellite system according to a first embodiment of the present invention, and a method for measuring the distance between artificial satellites. The method for measuring the distance between the artificial satellites according to the present embodiment can be performed by the artificial satellite system according to the present embodiment.

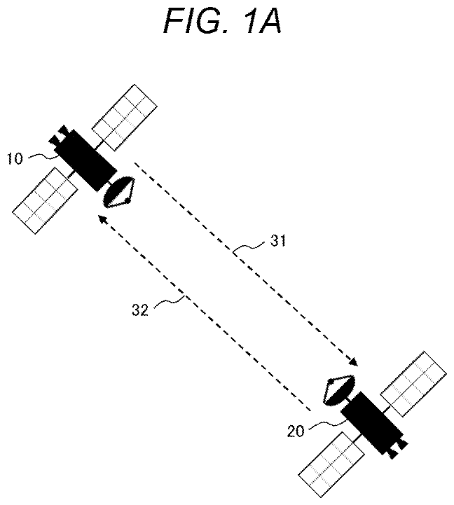

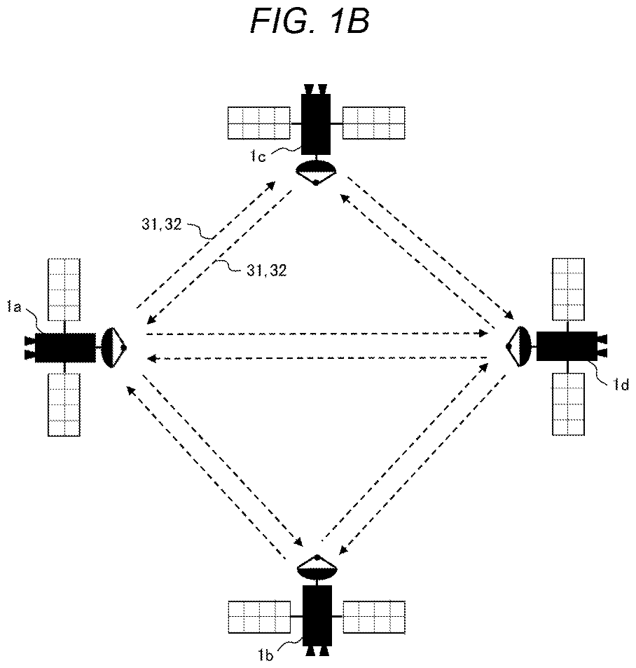

FIGS. 1A and 1B are diagrams each showing an example of a plurality of artificial satellites included in the artificial satellite system according to the present embodiment. The artificial satellite system according to the present embodiment includes a plurality of artificial satellites, that is, one transmitting artificial satellite 10 and one or more receiving artificial satellites 20. The transmitting artificial satellite 10 also has a configuration and function as the receiving artificial satellite 20. The receiving artificial satellite 20 also has a configuration and function as the transmitting artificial satellite 10. The transmitting artificial satellite 10 and the receiving artificial satellite 20 are, for example, artificial satellites for earth observation, which fly in a geostationary orbit (orbit at an altitude of approximately 36,000 km above the equator).

FIG. 1A illustrates an example in which the artificial satellite system according to the present embodiment is configured of two artificial satellites. The artificial satellite system illustrated in FIG. 1A includes a single transmitting artificial satellite 10 and a single receiving artificial satellite 20.

For example, the transmitting artificial satellite 10 transmits a radio wave 31 for measuring a relative distance to the receiving artificial satellite 20 to the receiving artificial satellite 20. If, after the radio wave 31 is received, it is a radio wave in a frequency band assigned to the receiving artificial satellite 20, the receiving artificial satellite 20 transmits a radio wave 32 having the same frequency and phase as the received radio wave 31 to the transmitting artificial satellite 10. Hereinafter, as for the transmitting artificial satellite 10 and the receiving artificial satellite 20, the radio wave to be transmitted is also called a transmission signal, and the radio wave to be received is also called a reception signal.

The transmitting artificial satellite 10 receives the radio wave 32 transmitted from the receiving artificial satellite 20 and determines by calculating the relative distance between the transmitting artificial satellite 10 and the receiving artificial satellite 20 from the difference between a transmission time of the radio wave 31 and a reception time of the radio wave 32, the phase difference between the transmission signal (radio wave 31) and the reception signal (radio wave 32), and in-circuit processing times of the transmitting artificial satellite 10 and the receiving artificial satellite 20. Note that the in-circuit processing times are the times required for signal processing by circuits included in the transmitting artificial satellite 10 and the receiving artificial satellite 20. The in-circuit processing times of the transmitting artificial satellite 10 and the receiving artificial satellite 20 can be determined by measuring in advance.

In the artificial satellite system according to the present embodiment, as described above, the receiving artificial satellite 20 receives the radio wave 31 transmitted by the transmitting artificial satellite 10, the receiving artificial satellite 20 transmits the radio wave 32 having the same frequency and phase as the received radio wave 31, and the transmitting artificial satellite 10 receives the radio wave 32. That is, the transmitting artificial satellite 10 receives the radio wave 32 having the same frequency and phase as the radio wave 31 transmitted to the receiving artificial satellite 20 from the receiving artificial satellite 20.

The transmitting artificial satellite 10 and the receiving artificial satellite 20 have the same configuration with each other and can switch between the operation as a transmitting artificial satellite and the operation as a receiving artificial satellite. That is, the transmitting artificial satellite 10 can also be operated as the receiving artificial satellite 20 which receives the transmission signal, and the receiving artificial satellite 20 can also be operated as the transmitting artificial satellite 10 which transmits the transmission signal. For example, the transmitting artificial satellite 10 and the receiving artificial satellite 20 are configured to be capable of transmission of a transmission signal, reception of a reception signal, reception of a transmission signal, and transmission of a reception signal.

In the artificial satellite system according to the present embodiment, the relative distances can be measured among the multiple artificial satellites without time synchronization in this way. Further, the receiving artificial satellite 20 transmits the radio wave 32 having the same frequency and phase as the received radio wave 31 to the transmitting artificial satellite 10 in terms of the radio wave in the frequency band assigned to itself. In the artificial satellite system according to the present embodiment, the relative distances among the multiple artificial satellites can be measured simultaneously by changing and assigning the frequency bands processed by the artificial satellites for each artificial satellite.

FIG. 1B shows an example in which the artificial satellite system according to the present embodiment includes four artificial satellites 1a to 1d. The four artificial satellites 1a to 1d have the same configuration with each other and can switch between the operation as the transmitting artificial satellite 10 and the operation as the receiving artificial satellite 20.

For example, the artificial satellite 1a is operated as the transmitting artificial satellite 10, each of the artificial satellites 1b to 1d is operated as the receiving artificial satellite 20, and the artificial satellite 1a transmits a radio wave 31 and receives a radio wave 32. With this, it is possible to measure the relative distance between the artificial satellite 1a and each of the artificial satellites 1b to 1d. Further, for example, the artificial satellite 1b is operated as the transmitting artificial satellite 10, each of the artificial satellites 1a and 1c to 1d is operated as the receiving artificial satellite 20, and the artificial satellite 1b transmits a radio wave 31 and receives a radio wave 32. With this, it is possible to measure the relative distance between the artificial satellite 1b and each of the artificial satellites 1a and 1c to 1d.

As described above, since each of the artificial satellites 1a to 1d is assigned the frequency band to be processed, the relative distances among the multiple artificial satellites 1a to 1d can be measured simultaneously in the artificial satellite system according to the present embodiment.

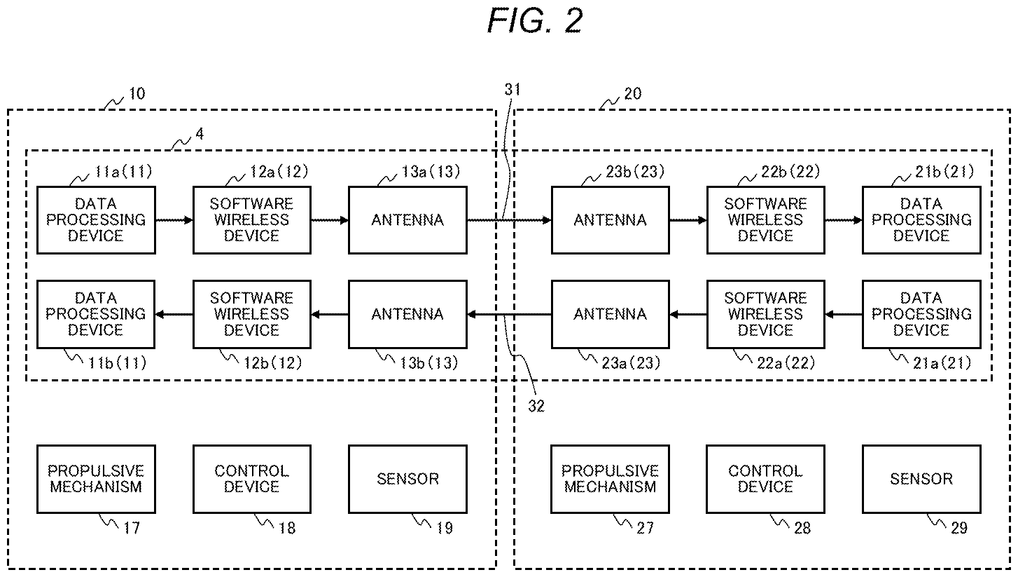

FIG. 2 is a block diagram showing an example of a schematic configuration of the artificial satellite system according to the present embodiment. The artificial satellite system 4 according to the present embodiment includes a transmitting artificial satellite 10 and a receiving artificial satellite 20.

The transmitting artificial satellite 10 is an artificial satellite which transmits a radio wave 31 and measures a relative distance to the receiving artificial satellite 20. The receiving artificial satellite 20 is an artificial satellite which returns a radio wave 32 having the same frequency and phase as the received radio wave 31 to the transmitting artificial satellite 10 and whose relative distance is measured by the transmitting artificial satellite 10.

The transmitting artificial satellite 10 includes data processing devices 11a and 11b, software defined radios 12a and 12b, and antennas 13a and 13b. The receiving artificial satellite 20 includes data processing devices 21a and 21b, software defined radios 22a and 22b, and antennas 23a and 23b. Further, the transmitting artificial satellite 10 and the receiving artificial satellite 20 include control devices 18 and 28 for controlling the attitudes of the artificial satellites 10 and 20, propulsive mechanisms 17 and 27 for driving the artificial satellites 10 and 20, and sensors 19 and 29 for grasping the states of the artificial satellites 10 and 20, respectively. For example, any thruster or electric propulsion device or the like can be used for the propulsive mechanisms 17 and 27.

Each of the data processing devices 11a, 11b, 21a, and 21b is a calculation device and has a function of calculating the relative distance between the transmitting artificial satellite 10 and the receiving artificial satellite 20 using the difference between a transmission time of a transmission signal (radio wave 31) and a reception time of a reception signal (radio wave 32), and the phase difference between the transmission signal and the reception signal. Further, each of the data processing devices 11a, 11b, 21a, and 21b has a function of controlling each of the software defined radios 12a, 12b, 22a, and 22b. The data processing devices 11a and 11b included in the transmitting artificial satellite 10 may be configured of one data processing device, or they may be configured of data processing devices different from each other. The data processing devices 21a and 21b included in the receiving artificial satellite 20 may be configured of one data processing device, or they may be configured of data processing devices different from each other.

The software defined radios 12a and 22a, and 12b and 22b respectively have a function of generating the signal of a radio wave to be transmitted and a function of processing a received radio wave.

Each of the software defined radios 12a and 22a has a function of according to a command from each of the data processing devices 11a and 21a, generating an analog signal corresponding to the command. For example, the software defined radio 22a included in the receiving artificial satellite 20 generates a radio wave (analog signal) having the same frequency and phase as the radio wave received from the transmitting artificial satellite 10 by the receiving artificial satellite 20. When the software defined radio 22a has a frequency filter function to be described later, the software defined radio 22a generates a radio wave having the same frequency and phase as the signal passed by the frequency filter function.

The software defined radios 12b and 22b each have a function of processing the received radio wave, e.g., a function of converting the analog signal received by each of the transmitting artificial satellite 10 and the receiving artificial satellite 20 into a digital signal. In the transmitting artificial satellite 10, the software defined radio 12a and the software defined radio 12b may be configured of one software defined radio, or they may be configured of software defined radios different from each other. In the receiving artificial satellite 20, the software defined radio 22a and the software defined radio 22b may be configured of one software defined radio, or they may be configured of software defined radios different from each other.

The antennas 13a and 23a have a function for transmitting analog signals generated by the software defined radios 12a and 22a as radio waves. Each of the antennas 13b and 23b has a function for receiving a radio wave. In each of the transmitting artificial satellite 10 and the receiving artificial satellite 20, the antenna to transmit the radio wave and the antenna to receive the radio wave may be configured of one antenna, or they may be configured of antennas different from each other. Further, the transmitting artificial satellite 10 and the receiving artificial satellite 20 may each have a plurality of antennas 13b and 23b which receive the radio waves.

In the following, the data processing devices 11a and 11b may also be represented as a data processing device 11, the software defined radios 12a and 12b may also be represented as a software defined radio 12, the antennas 13a and 13b may also be represented as an antenna 13, the data processing devices 21a and 21b may also be represented as a data processing device 21, the software defined radios 22a and 22b may also be represented as a software defined radio 22, and the antennas 23a and 23b may also be represented as an antenna 23, respectively.

According to the command from the data processing device 11, the control devices 18 and 28 are capable of controlling the propulsive mechanisms 17 and 27 to drive the artificial satellites 10 and 20.

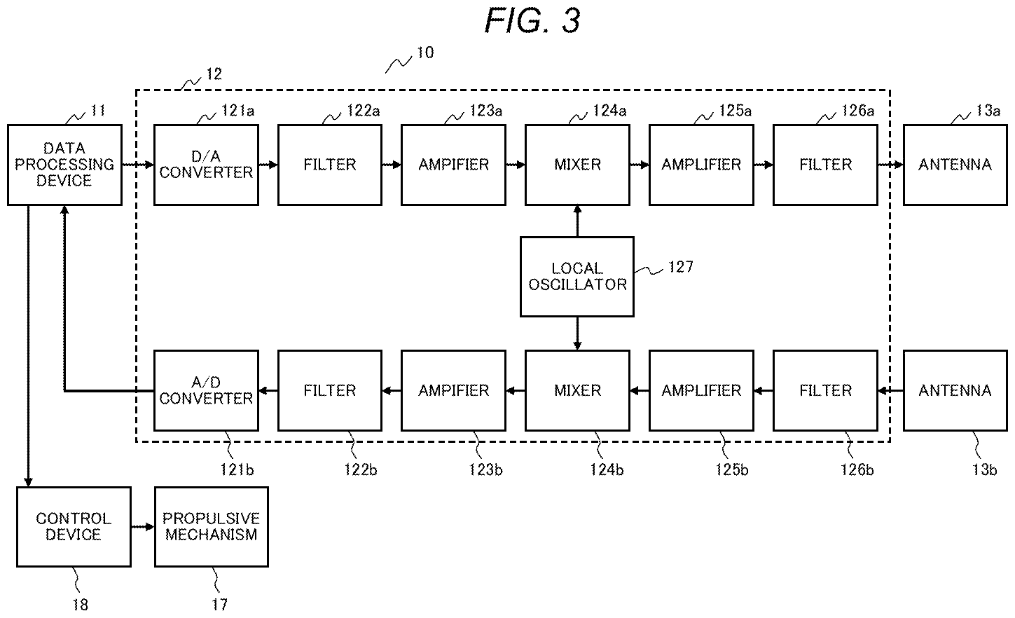

FIG. 3 is a diagram showing in more detail an example of basic configurations of the transmitting artificial satellite 10 and the receiving artificial satellite 20. As described above, the transmitting artificial satellite 10 and the receiving artificial satellite 20 has the same configuration with each other. Therefore, hereinafter, the transmitting artificial satellite 10 will be described as a representative, and the basic configuration of the transmitting artificial satellite 10 is shown in FIG. 3. Further, in FIG. 3, for the sake of simplification of the drawing, the data processing devices 11a and 11b and the software defined radios 12a and 12b are shown as one data processing device 11 and one software defined radio 12, respectively.

As a configuration for transmitting a radio wave, the software defined radio 12 includes a D/A converter 121a, a filter 122a, an amplifier 123a, a mixer 124a, an amplifier 125a, and a filter 126a. Also, as a configuration for receiving a radio wave, the software defined radio 12 includes a filter 126b, an amplifier 125b, a mixer 124b, an amplifier 123b, a filter 122b, and an A/D converter 121b. Further, the software defined radio 12 has a local oscillator 127. The local oscillator 127 is a device which generates a signal for modulation (frequency conversion) of an analog signal.

A description will first be made about the configuration for transmitting the radio wave in terms of the transmitting artificial satellite 10.

The D/A converter 121a (digital-analog converter 121a) performs D/A conversion (digital-analog conversion) according to a command from the data processing device 11 to generate an analog signal. The filter 122a eliminates high frequency noise caused by the D/A conversion from the generated analog signal. The amplifier 123a amplifies the amplitude of the generated analog signal. The mixer 124a modulates the generated analog signal. That is, the mixer 124a converts the frequency of the analog signal by multiplying the generated analog signal by the signal from the local oscillator 127. The amplifier 125a amplifies the amplitude of the modulated analog signal. The filter 126a eliminates a noise component from the modulated analog signal. The antenna 13a converts the modulated analog signal (electric signal) into a radio wave.

Note that the software defined radio 12 may include one or more of the filter 122a, the filter 126a, the amplifier 123a, and the amplifier 125a, or may not include any of these.

A description will next be made about the configuration for receiving the radio wave in terms of the transmitting artificial satellite 10.

The antenna 13b converts the received radio wave into an electric analog signal. The filter 126b eliminates a noise component from the analog signal. The amplifier 125b amplifies the amplitude of the analog signal. The mixer 124b modulates the analog signal. That is, the mixer 124b converts the frequency of the analog signal by multiplying the analog signal by the signal from the local oscillator 127. The amplifier 123b amplifies the amplitude of the modulated analog signal. The filter 122b eliminates noise or an unnecessary frequency band caused by the frequency conversion from the modulated analog signal. The A/D converter 121b (analog-digital converter 121b) performs A/D conversion (analog-digital conversion) to convert the modulated analog signal into a digital signal.

Note that the software defined radio 12 may include one or more of the filter 126b, the filter 122b, the amplifier 125b, and the amplifier 123b, or may not include any of these.

In the present embodiment, the transmitting artificial satellite 10 uses the same local oscillator 127 when transmitting and receiving the radio waves. That is, the software defined radio 12 performs frequency conversion processing in generating a transmission signal and frequency conversion processing for a reception signal. When the error in initial phase occurs in the local oscillator 127, phase errors occur when the mixers 124a and 124b each covert the frequency of the analog signal. In the present embodiment, since the same local oscillator 127 is used when transmitting and receiving the radio waves, it is possible to cancel out the phase errors each other, and it is possible to prevent the error in the initial phase due to the local oscillator 127 from occurring.

Further, since the transmitting artificial satellite 10 and the receiving artificial satellite 20 have the same configuration with each other, it is easy to mutually switch the transmitting artificial satellite 10 and the receiving artificial satellite 20. Therefore, the relative distances between one artificial satellite and one or more artificial satellites can be easily measured even from any artificial satellite.

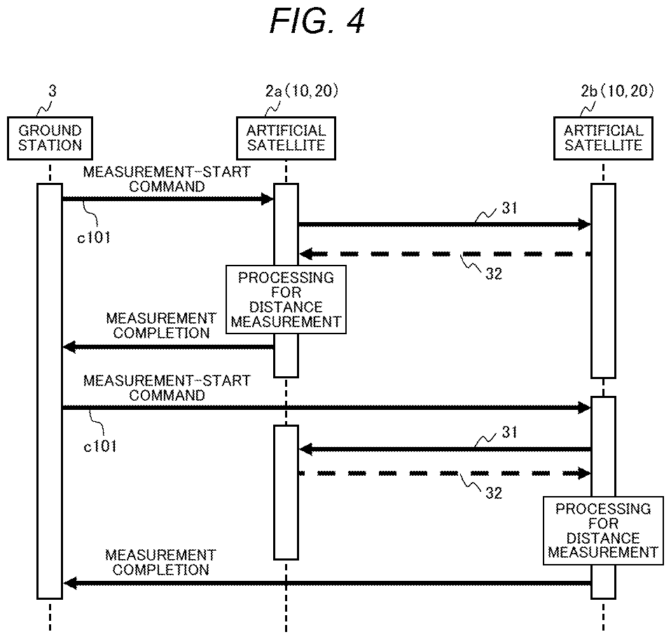

FIG. 4 is a diagram showing an example of sequence control when measuring the relative distance between the transmitting artificial satellite 10 and the receiving artificial satellite 20 by mutually switching the transmitting artificial satellite 10 and the receiving artificial satellite 20. Two artificial satellites 2a and 2b are shown in FIG. 4.

Using FIG. 4, a description will be made about a case where the artificial satellite 2a serves as the transmitting artificial satellite 10 and the artificial satellite 2b serves as the receiving artificial satellite 20, and a case where the artificial satellite 2b serves as the transmitting artificial satellite 10 and the artificial satellite 2a serves as the receiving artificial satellite 20. First, the artificial satellite 2a serving as the transmitting artificial satellite 10 measures the relative distance to the artificial satellite 2b serving as the receiving artificial satellite 20. Next, the artificial satellite 2b serving as the transmitting artificial satellite 10 measures the relative distance to the artificial satellite 2a serving as the receiving artificial satellite 20.

First, a ground station 3 on the ground transmits a measurement-start command c101 to the artificial satellite 2a which serves as the transmitting artificial satellite 10. Then, the artificial satellite 2a transmits a radio wave 31 to the artificial satellite 2b which serves as the receiving artificial satellite 20. Further, the artificial satellite 2a receives a radio wave 32 from the artificial satellite 2b to determine the relative distance to the artificial satellite 2b and transmits a signal indicating that the measurement of the relative distance is completed to the ground station 3.

Next, the ground station 3 transmits a measurement-start command c101 to the artificial satellite 2b which serves as the transmitting artificial satellite 10. Then the artificial satellite 2b transmits a radio wave 31 to the artificial satellite 2a which serves as the receiving artificial satellite 20. Further, the artificial satellite 2b receives a radio wave 32 from the artificial satellite 2a to determine the relative distance to the artificial satellite 2a and transmits a signal indicating that the measurement of the relative distance is completed to the ground station 3.

Note that mutual switching between the transmitting artificial satellite 10 and the receiving artificial satellite 20 may be performed by transmitting the measurement-start command c101 by the ground station 3 as in the example shown in FIG. 4, or it may be performed by any other method.

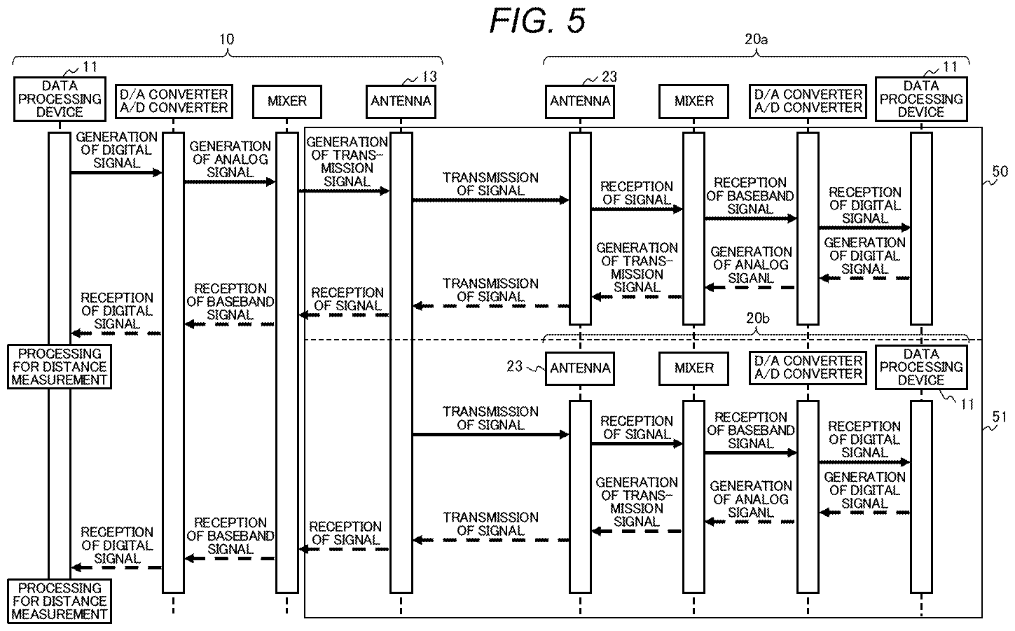

FIG. 5 is a diagram showing an example of sequence control of the artificial satellite system according to the present embodiment. A description will be made about the configuration of the artificial satellite system according to the present embodiment with reference to FIG. 5.

Hereinafter, for the purpose of simplifying the description, a description will be made about an example in which the artificial satellite system includes one transmitting artificial satellite 10 and two receiving artificial satellites 20 (receiving artificial satellite 20a and receiving artificial satellite 20b). However, the artificial satellite system according to the present embodiment is not limited to this example and can include an arbitrary number of transmitting artificial satellites 10 and receiving artificial satellites 20.

In FIG. 5, processing 50 to measure the relative distance to the receiving artificial satellite 20a by the transmitting artificial satellite 10 and processing 51 to measure the relative distance to the receiving artificial satellite 20b by the transmitting artificial satellite 10 are executed in parallel.

The data processing device 11 of the transmitting artificial satellite 10 generates a digital signal for transmitting a transmission signal (i.e., radio wave 31).

The D/A converter 121a of the software defined radio 12 of the transmitting artificial satellite 10 generates an analog signal expressed by an equation (1), for example according to a command from the data processing device 11. Note that the analog signal of the equation (1) is a common signal as an example, and the transmitting artificial satellite 10 may generate any other signal, for example, a signal having a certain frequency bandwidth.

$$\begin{matrix}{S}_{1} ( t ) = {e}^{j 2 π {f}_{1} ( t - Δ {t}_{DA 1} )} + {e}^{j 2 π {f}_{2} ( t - Δ {t}_{DA 1} )} \\ = {e}^{j 2 π {f}_{1} t} {e}^{j {φ}_{DA 11}} + {e}^{j 2 π {f}_{2} t} {e}^{j {φ}_{DA 12}}\end{matrix} \qquad ( 1 )$$

In the equation (1), j indicates an imaginary unit, f₁ and f₂ indicate the frequencies of analog signals, Δt_{DA1} indicates a processing time associated with digital-analog conversion, ϕ_{DA11} indicates a phase difference caused due to a processing time difference in the signal of the frequency f₁, and ϕ_{DA12} indicates a phase difference caused due to a processing time difference in the signal of the frequency f₂. The frequency f₁ is included in a frequency band assigned to the receiving artificial satellite 20a. The frequency f₂ is included in a frequency band assigned to the receiving artificial satellite 20b.

The processing time Δt_{DA1} is a value which depends on the processing performance of the D/A converter 121a. The processing time becomes a constant value for a constant signal amount unless the influence of noise is considered. Therefore, the processing time Δt_{DA1} is a value which can be determined by measuring it in advance as the in-circuit processing time. The phase difference ϕ_{DA11} and the phase difference ϕ_{DA12} can also be determined from the in-circuit processing time measured in advance.

The mixer 124a of the software defined radio 12 converts the frequency of an analog signal and generates a transmission signal (i.e., radio wave 31) of the transmitting artificial satellite 10. The frequency-converted analog signal is represented by an equation (2).

$$\begin{matrix}{S}_{2} ( t ) = ( {e}^{i 2 π {f}_{1} t} {e}^{j {φ}_{DA 11}} + {e}^{j 2 π {f}_{2} t} {e}^{j {φ}_{DA 12}} ) ( {e}^{j 2 π {f}_{L . O} t} {e}^{j {φ}_{1}} ) \\ = {e}^{j 2 π ( {f}_{1} + {f}_{L . o .} ) t} {e}^{j ( {φ}_{DA 11} + {φ}_{1} )} + {e}^{j 2 π ( {f}_{2} + {f}_{L . o .} ) t} {e}^{j ( {φ}_{DA 12} + {φ}_{1} )}\end{matrix} \qquad ( 2 )$$

In the equation (2), ϕ₁ indicates an error in the initial phase of the local oscillator 127 of the transmitting artificial satellite 10, and f_{L.O.} indicates the frequency of the signal generated by the local oscillator 127.

The antenna 13 of the transmitting artificial satellite 10 transmits the transmission signal to the receiving artificial satellite 20a and the receiving artificial satellite 20b.

The antennas 23 of the receiving artificial satellite 20a and the receiving artificial satellite 20b receive the transmission signals from the transmitting artificial satellite 10. The signals received by the receiving artificial satellite 20a and the receiving artificial satellite 20b are represented by equations (3) and (4) respectively.

$$\begin{matrix}{S}_{3} ( t ) = {e}^{j 2 π ( {f}_{1} + {f}_{L . o .} ) t} {e}^{j ( {φ}_{DA 11} + {φ}_{1} + {φ}_{la 1} )} \\ + {e}^{j 2 π ( {f}_{2} + {f}_{L . o .} ) t} {e}^{j ( {φ}_{DA 12} + {φ}_{1} + {φ}_{la 2} )}\end{matrix} \qquad ( 3 )$$

$$\begin{matrix}{S}_{4} ( t ) = {e}^{j 2 π ( {f}_{1} + {f}_{L . o .} ) t} {e}^{j ( {φ}_{DA 11} + {φ}_{1} + {φ}_{l b 1} )} \\ + {e}^{j 2 π ( {f}_{2} + {f}_{L . o .} ) t} {e}^{j ( {φ}_{DA 12} + {φ}_{1} + {φ}_{l b 2} )}\end{matrix} \qquad ( 4 )$$

In the equation (3), phase differences ϕₗₐ₁ and ϕₗₐ₂ are phase differences which occur in the process of radio waves propagating from the transmitting artificial satellite 10 to the receiving artificial satellite 20a. In the equation (4), phase differences ϕ_{lb1} and ϕ_{lb1} are phase differences which occur in the process of radio waves propagating from the transmitting artificial satellite 10 to the receiving artificial satellite 20b.

Both the signals represented by the equations (3) and (4) are represented by the sum of a signal of a frequency (f₁+f_{L.O.}) and a signal of a frequency (f₂+f_{L.O.}) and include a signal processed by the receiving artificial satellite 20a and a signal processed by the receiving artificial satellite 20b.

The phase differences included in the equations (3) and (4) depend on the distance between the artificial satellites and the frequency of the transmission signal, and are respectively represented by equations (5) and (6) using the speed of light c.

$${φ}_{la 1} = \frac{2 π ( {f}_{1} + {f}_{L . O .} ) \cdot {l}_{a}}{c} , {φ}_{la 2} = \frac{2 π ( {f}_{2} + {f}_{L . O .} ) \cdot {l}_{a}}{c} \qquad ( 5 )$$

$${φ}_{l b 1} = \frac{2 π ( {f}_{1} + {f}_{L . O .} ) \cdot {l}_{b}}{c} , {ϕ}_{l b 2} = \frac{2 π ( {f}_{2} + {f}_{L . O .} ) \cdot {l}_{b}}{c} \qquad ( 6 )$$

In the equation (5), lₐ is the distance between the transmitting artificial satellite 10 and the receiving artificial satellite 20a. In the equation (6), l_{b} is the distance between the transmitting artificial satellite 10 and the receiving artificial satellite 20b.

The mixers 124b of the software defined radios 22 in the receiving artificial satellites 20a and 20b convert the frequencies of the signals received by the receiving artificial satellites 20a and 20b. The signals (baseband signals) generated by converting the frequencies by the mixers 124b of the receiving artificial satellites 20a and 20b are represented by equations (7) and (8) respectively.

$$\begin{matrix}{S}_{5} ( t ) = {e}^{j 2 π {f}_{1} t} {e}^{j ( {φ}_{DA 11} + {φ}_{1} + {φ}_{la 1} - {φ}_{2 a} )} \\ + {e}^{j 2 π {f}_{2} t} {e}^{j ( {φ}_{DA 12} + {φ}_{1} + {φ}_{la 2} - {φ}_{2 a} )}\end{matrix} \qquad ( 7 )$$

$$\begin{matrix}{S}_{6} ( t ) = {e}^{j 2 π {f}_{1} t} {e}^{j ( {φ}_{DA 11} + {φ}_{1} + {φ}_{l b 1} - {φ}_{2 b} )} \\ + {e}^{j 2 π {f}_{2} t} {e}^{j ( {φ}_{DA 12} + {φ}_{1} + {φ}_{l b 2} - {φ}_{2 b} )}\end{matrix} \qquad ( 8 )$$

In the equation (7), ϕ₂ₐ is an error in the initial phase of the local oscillator 127 of the receiving artificial satellite 20a. In the equation (8), ϕ_{2b} is an error in the initial phase of the local oscillator 127 of the receiving artificial satellite 20b.

As described above, each of the receiving artificial satellites 20a and 20b is assigned with the frequency band of the signal (radio wave) to be processed. Each of the software defined radios 22 of the receiving artificial satellites 20a and 20b has the frequency filter function which allows only the signal (radio wave) in the frequency band assigned to each of the receiving artificial satellites 20a and 20b to pass through. That is, using the frequency filter function of the software defined radio 22, each of the receiving artificial satellites 20a and 20b is capable of processing only the signal in the frequency band assigned to itself, of the received signals and transmitting the signal having the same frequency and phase as the signal passed through by the frequency filter function to the first artificial satellite 10.

Here, the frequency filter function of the software defined radio 22 will be described.

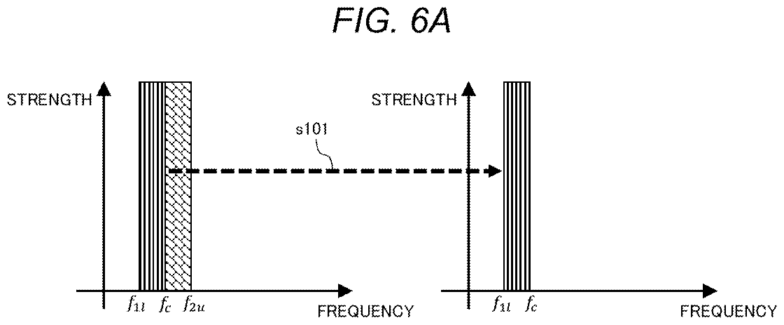

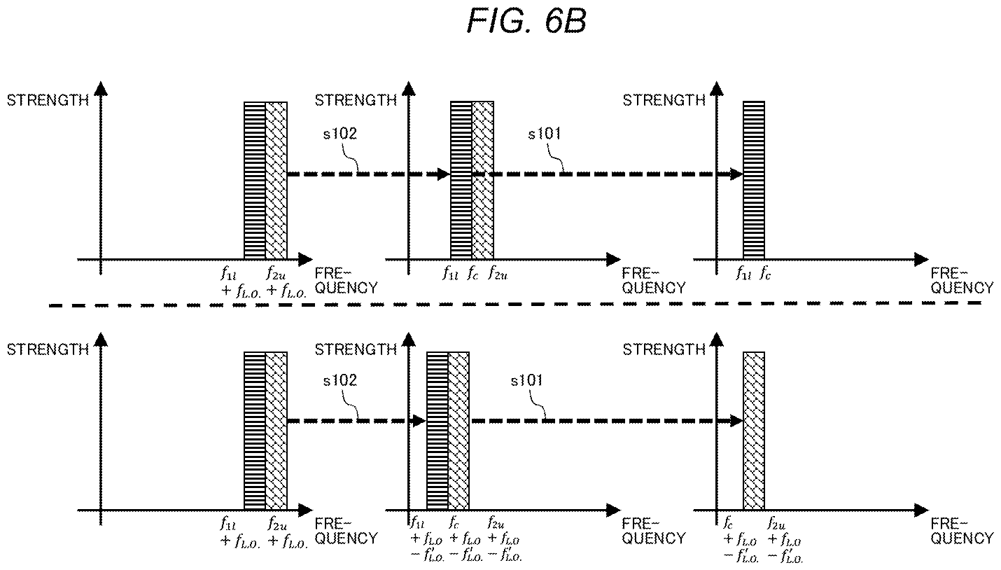

FIG. 6A is a diagram for describing the frequency filter function. An example of the distribution of strength versus frequency of the signal is shown in FIG. 6A.

As shown in the left diagram of FIG. 6A, for example, the frequency band of the signal received by the receiving artificial satellite 20a is assumed to be f₁ₗ to f₂ᵤ. Further, the frequency band assigned to the receiving artificial satellite 20a is assumed to be f₁ₗ to f_{c}. Then, the receiving artificial satellite 20a uses the filter function s101 to allow only the signals in the range of the frequency band of f₁ₗ to f_{c} among the received signals to pass therethrough as shown in the right diagram of FIG. 6A.

Assuming that the frequency band assigned to the receiving artificial satellite 20b is f_{c} to f₂ᵤ, and the receiving artificial satellite 20b receives the signals in the frequency band of f₁ₗ to f₂ᵤ, the receiving artificial satellite 20b uses the filter function to allow only the signals in the range of the frequency band of f_{c} to f₂ᵤ among the received signals to pass therethrough.

Further, the frequency filter function in each of the receiving artificial satellites 20a and 20b may extract the signals to be passed by fixing the frequency band to be filtered and adjusting the frequency of the signal generated by the local oscillator 127. That is, the frequency filter function can be achieved by changing the frequency to be frequency-converted (frequency to be shifted), without changing the frequency band to be filtered according to the frequency band assigned to each of the receiving artificial satellites 20a and 20b.

FIG. 6B is a diagram for describing the frequency filter function of adjusting the frequency of the signal generated by the local oscillator 127. An example of the distribution of strength versus frequency of the signal is illustrated in FIG. 6B. FIG. 6B illustrates such that in a strength distribution in an upper stage and a strength distribution in a lower stage, the magnitudes of the corresponding frequencies become equal to each other. In the example illustrated in FIG. 6B, to make the description easier to understand, the receiving artificial satellite 20a and the receiving artificial satellite 20b are configured to allow only the signals in the range of the same frequency band of f₁ₗ to f_{c} with each other to pass therethrough.

Assume that the frequency band to be filtered is fixed to f₁ₗ to f_{c} in the receiving artificial satellite 20a. In the receiving artificial satellite 20a, as illustrated in the left and central drawings in the upper stage of FIG. 6B, a frequency conversion function s102 shifts the frequency by the same amount (frequency f_{L.O.} of the signal generated by the local oscillator 127) as that in the transmitting artificial satellite 10. On the other hand, in the receiving artificial satellite 20b, as illustrated in the left and central drawings in the lower stage of FIG. 6B, a frequency conversion function s102 shifts the frequency by a frequency f′_{L.O.} (=f_{L.O.}+f_{c}−f₁ₗ). Thereafter, as illustrated in the central and right drawings in the upper stage of FIG. 6B and in the central and right drawings in the lower stage of FIG. 6B, a filter function s101 is used to allow only the signals in the range of the frequency band of f₁ₗ to f_{c} to pass through the receiving artificial satellite 20a and the receiving artificial satellite 20b.

Referring back to the description of the configuration of the artificial satellite system with reference to FIG. 5.

As already described, the frequencies of the signals received by the receiving artificial satellites 20a and 20b are converted by the mixers 124b of the software defined radios 22 of the receiving artificial satellites 20a and 20b to generate the baseband signals (equations (7) and (8)).

The signals transmitted to the transmitting artificial satellite 10 from the receiving artificial satellites 20a and 20b are represented by equations (9) and (10) respectively.

$$\begin{matrix}{S}_{7} ( t ) = {e}^{i 2 π {f}_{1} t} {e}^{j ( {φ}_{DA 11} + {φ}_{1} + {φ}_{la 1} - {φ}_{2 a} + {φ}_{AD 2 a} + {φ}_{DA 2 a} )} {e}^{j 2 π {f}_{L . O .} t} {e}^{j {φ}_{2 a}} \\ = {e}^{j 2 π ( {f}_{1} + {f}_{L . O .} ) t} {e}^{j ( {φ}_{DA 11} + {φ}_{1} + {φ}_{la 1} + {φ}_{AD 2 a} + {φ}_{DA 2 a} )}\end{matrix} \qquad ( 9 )$$

$$\begin{matrix}{S}_{8} ( t ) = {e}^{i 2 π {f}_{2} t} {e}^{j ( {φ}_{DA 11} + {φ}_{1} + {φ}_{l b 1} - {φ}_{2 b} + {φ}_{AD 2 b} + {φ}_{DA 2 b} )} {e}^{j 2 π {f}_{L . O .} t} {e}^{j {φ}_{2 b}} \\ = {e}^{j 2 π ( {f}_{2} + {f}_{L . O .} ) t} {e}^{j ( {φ}_{DA 12} + {φ}_{1} + {φ}_{l b 2} + {φ}_{AD 2 b} + {φ}_{DA 2 b} )}\end{matrix} \qquad ( 10 )$$

In the equation (9), ϕ_{AD2a} and ϕ_{DA2a} are respectively phase differences which occur accompanying processing times for analog-to-digital conversion and digital-to-analog conversion of the receiving artificial satellite 20a. In the equation (10), ϕ_{AD2b} and ϕ_{DA2b} are respectively phase differences which occur accompanying processing times for analog-to-digital conversion and digital-to-analog conversion of the receiving artificial satellite 20b. These processing times depend on the performance of the A/D converter 121b and the D/A converter 121a and become constant values for a constant signal amount unless the influence of noise is taken into consideration. Therefore, these processing times are values which can be determined by measuring the same in advance as the in-circuit processing times. The above phase differences can be determined from the in-circuit processing times measured in advance.

The receiving artificial satellites 20a and 20b respectively receive the signals represented by the equations (3) and (4) from the transmitting artificial satellite 10 and transmit the radio waves each having the same frequency and phase as the signals represented by the equations (3) and (4) to the transmitting artificial satellite 10. The signals represented by the equations (9) and (10) are signals that the receiving artificial satellites 20a and 20b transmit to the transmitting artificial satellite 10, and they can be considered to have the same frequency and phase as the signals represented by the equations (3) and (4).

However, the equations (9) and (10) indicate the signals passed by the receiving artificial satellites 20a and 20b through their frequency filter functions. Therefore, the signal represented by the equation (9) is a signal of a frequency (f₁+f_{L.O.}), and the signal represented by the equation (10) is a signal of a frequency (f₂+f_{L.O.}). Further, even if the signal received by each of the receiving artificial satellites 20a and 20b and the signal transmitted therefrom are intended to make the phases the same value, the phase difference associated with the analog-to-digital conversion and digital-to-analog conversion actually occurs. Therefore, the equations (9) and (10) indicate the signals each having the phase having considered the phase difference (ϕ_{AD2a}+ϕ_{DA2a} in the equation (9), and ϕ_{AD2b}+ϕ_{DA2b} in the equation (10)).

The signal received by the transmitting artificial satellite 10 is represented by an equation (11).

$$\begin{matrix}{S}_{9} ( t ) = {e}^{j 2 π ( {f}_{1} + {f}_{L . O .} ) t} {e}^{j ( {φ}_{DA 11} + {φ}_{1} + 2 {φ}_{la 1} + {φ}_{AD 2 a} + {φ}_{DA 2 a} )} \\ + {e}^{j 2 π ( {f}_{2} + {f}_{L . O .} ) t} {e}^{j ( {φ}_{DA 12} + {φ}_{1} + 2 {φ}_{l b 2} + {φ}_{AD 2 b} + {φ}_{DA 2 b} )}\end{matrix} \qquad ( 11 )$$

The mixer 124b of the software defined radio 12 of the transmitting artificial satellite 10 converts the frequency of the signal represented by the equation (11) to obtain a signal represented by an equation (12).

$$\begin{matrix}{S}_{10} ( t ) = {e}^{j 2 π {f}_{1} t} {e}^{j ( {φ}_{DA 11} + 2 {φ}_{la 1} + {φ}_{AD 2 a} + {φ}_{DA 2 a} )} \\ + {e}^{j 2 π {f}_{2} t} {e}^{j ( {φ}_{DA 12} + 2 {φ}_{l b 2} + {φ}_{AD 2 b} + {φ}_{DA 2 b} )}\end{matrix} \qquad ( 12 )$$

The data processing device 11 of the transmitting artificial satellite 10 measures the signal represented by the equation (12) as a signal represented by an equation (13).

$$\begin{matrix}{S}_{11} ( t ) = {e}^{j 2 π {f}_{1} t} {e}^{j ( {φ}_{DA 11} + 2 {φ}_{la 1} + {φ}_{AD 2 a} + {φ}_{DA 2 a} + {φ}_{AD 11} )} \\ + {e}^{j 2 π {f}_{2} t} {e}^{j ( {φ}_{DA 12} + 2 {φ}_{l b 2} + {φ}_{AD 2 b} + {φ}_{DA 2 b} + {φ}_{AD 12} )}\end{matrix} \qquad ( 13 )$$

Here, ϕ_{AD11} and ϕ_{AD12} are phase differences each of which occurs accompanying the processing time for the analog-to-digital conversion of the transmitting artificial satellite 10. The processing time depends on the performance of the A/D converter 121b and becomes a constant value for a constant signal amount unless the influence of noise is taken into consideration. Therefore, the processing time can be determined by measuring the same in advance as the in-circuit processing time. The phase differences ϕ_{AD11} and ϕ_{AD12} can also be determined from the in-circuit processing time measured in advance.

It is understood that as shown in the equation (13), the signal received by the transmitting artificial satellite 10 has information about a phase difference ϕₗₐ₁ corresponding to the distance between the transmitting artificial satellite 10 and the receiving artificial satellite 20a and a phase difference ϕ_{lb2} corresponding to the distance between the transmitting artificial satellite 10 and the receiving artificial satellite 20b.

The data processing device 11 of the transmitting artificial satellite 10 performs frequency analysis of a transmission signal and a reception signal. The data processing device 11 calculates the approximate value of the relative distance between the transmitting artificial satellite 10 and each of the receiving artificial satellites 20a and 20b from the difference between the transmission time of the transmission signal (radio wave 31) and the reception time of the reception signal (radio wave 32) according to an equation (14).

$$[ \begin{matrix}{l}_{a} \\ {l}_{b}\end{matrix} ] = [ \begin{matrix}Δ {T}_{a} \times c \\ Δ {T}_{b} \times c\end{matrix} ] \qquad ( 14 )$$

In the equation (14), lₐ is the relative distance between the transmitting artificial satellite 10 and the receiving artificial satellite 20a, and l_{b} is the relative distance between the transmitting artificial satellite 10 and the receiving artificial satellite 20b. Further, ΔTₐ indicates the time difference between the time (transmission time) at which the transmitting artificial satellite 10 transmits the signal, and the time (reception time) at which the transmitting artificial satellite 10 receives the signal transmitted by the receiving artificial satellite 20a. ΔT_{b} indicates the time difference between the time at which the transmitting artificial satellite 10 transmits the signal and the time at which the transmitting artificial satellite 10 receives the signal transmitted by the receiving artificial satellite 20b.

The data processing device 11 calculates the cross-power spectrum between the transmission signal and the reception signal and calculates a phase difference ϕ of each frequency component. The data processing device 11 corrects the calculated phase difference ϕ as in an equation (15) using the phase difference determined by measurement in advance, which is caused by the processing of the analog-to-digital conversion and the digital-to-analog conversion of the transmitting artificial satellite 10.

$$[ \begin{matrix}{φ}_{ca} \\ {φ}_{cb}\end{matrix} ] = [ \begin{matrix}φ - {φ}_{DA 11} - {φ}_{A D 2 a} - {φ}_{DA 2 a} - {φ}_{AD 11} \\ φ - {φ}_{DA 12} - {φ}_{AD 2 b} - {φ}_{DA 2 b} - {φ}_{DA 12}\end{matrix} ] \qquad ( 15 )$$

In the equation (15), ϕ_{ca} is the corrected phase difference for the transmitting artificial satellite 10 and the receiving artificial satellite 20a, and 99 _{cb} is the corrected phase difference for the transmitting artificial satellite 10 and the receiving artificial satellite 20b.

The data processing device 11 corrects the approximate value (equation (14)) of the relative distance between the transmitting artificial satellite 10 and each of the receiving artificial satellites 20a and 20b as in an equation (16) using the phase difference corrected like the equation (15), to thereby determine a relative distance lₐ between the transmitting artificial satellite 10 and the receiving artificial satellite 20a and a relative distance 1b between the transmitting artificial satellite 10 and the receiving artificial satellite 20b.

$$[ \begin{matrix}{l}_{a} \\ {l}_{b}\end{matrix} ] = [ \begin{matrix}\frac{c}{2 ( {f}_{1} + {f}_{L . O .} )} \{ quotient ( \frac{{l}_{a}}{λ} ) + \frac{{φ}_{c a}}{2 π} \} \\ \frac{c}{2 ( {f}_{2} + {f}_{L . O .} )} \{ quotient ( \frac{{l}_{b}}{λ} ) + \frac{{φ}_{cb}}{2 π} \}\end{matrix} ] \qquad ( 16 )$$

In the equation (16), quotient represents the quotient of division.

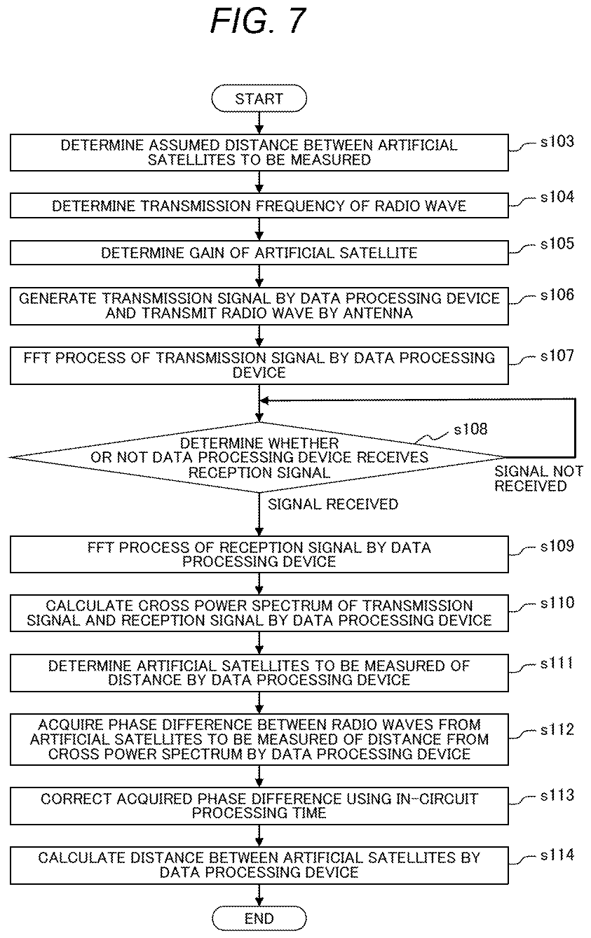

FIG. 7 is a diagram showing an example of a flowchart of a method for measuring the distance between the artificial satellites, according to the present embodiment. The flowchart shown in FIG. 7 is executed by the transmitting artificial satellite 10 which measures the relative distance to the receiving artificial satellite 20.

An example of a procedure for the method for measuring the distance between the artificial satellites will be described using FIG. 7. The method for measuring the distance between the artificial satellites, according to the present embodiment may be performed by other procedures and methods without being not limited to the procedure and method shown in the flowchart of FIG. 7.

In processing step s103, an operator or the data processing device 11 of the transmitting artificial satellite 10 determines an assumed distance for the relative distance between the artificial satellites desired to be measured. In the present embodiment, the assumed distance is an approximate distance assumed as the relative distance between the transmitting artificial satellite 10 and the receiving artificial satellite 20. The assumed distance may be determined by, for example, operation conditions of the artificial satellite or may be determined from conditions for placing each artificial satellite into the orbit.

In processing step s104, the operator or the data processing device 11 determines the frequency of a radio wave 31 transmitted by the transmitting artificial satellite 10. This frequency is preferably determined based on the assumed distance determined in processing step s103. For example, it is desirable to determine the frequency of the radio wave 31 so that the radio wave 31 has a wavelength longer than the assumed distance.

In processing step s105, the operator or the data processing device 11 determines the gain of each of the amplifiers 123a, 123b, 125a, and 125b of the transmitting artificial satellite 10 and the receiving artificial satellite 20. The gain is preferably determined based on the assumed distance determined in processing step s103. For example, since the radio wave is reduced in strength due to its propagation, it is desirable that the gain is larger as the assumed distance determined in processing step s103 is longer.

In processing step s106, the transmitting artificial satellite 10 generates a transmission signal (signal of radio wave 31) by the data processing device 11 and transmits the radio wave 31 through the antenna 13a.

In processing step s107, the data processing device 11 performs processing of fast Fourier Transform (FFT) to the transmission signal. With the processing of fast Fourier Transform, the data processing device 11 can perform frequency analysis of the signal (transmission signal) of the transmitted radio wave 31.

In processing step s108, the data processing device 11 determines whether or not the radio wave 32 (reception signal) from the receiving artificial satellite 20 have been received, that is, whether the reception signal is present or absent. When it is determined that the reception signal is present, processing in processing step s109 is executed. Note that the transmitting artificial satellite 10 is able to receive the radio waves 32 from the multiple receiving artificial satellites 20.

In processing step s109, the data processing device 11 performs processing of fast Fourier Transform (FFT) to the reception signal. With the processing of fast Fourier Transform, the data processing device 11 performs frequency analysis of the signal (reception signal) of the received radio wave 32, and can determine whether the reception signal is a signal transmitted from any artificial satellite.

In processing step s110, the data processing device 11 calculates the cross-power spectrum between the reception signal and the transmission signal. The data processing device 11 calculates the cross-power spectrum by multiplying those obtained by making a result of the fast Fourier Transform processing of the transmission signal conjugated with a result of the fast Fourier Transform processing of the reception signal.

In processing step s111, the data processing device 11 determines the receiving artificial satellite 20 which measures the relative distance. The data processing device 11 can determine, for example, a predetermined receiving artificial satellite 20 or a receiving artificial satellite 20 commanded from outside among the multiple receiving artificial satellites 20 as the receiving artificial satellite 20 which measures the relative distance.

In processing step s112, the data processing device 11 determines the phase difference between the transmission signal (radio wave 31) and the reception signal (radio wave 32) from the cross-power spectrum calculated in processing step s110 in terms of the radio waves in the frequency band assigned to the receiving artificial satellite 20 determined in processing step s111. As a result, the transmitting artificial satellite 10 is capable of acquiring the phase difference between the radio wave 32 received from the receiving artificial satellite 20 that measures the relative distance and the transmitted radio wave 31.

In processing step s113, the data processing device 11 subtracts the correction value (value obtained by converting the in-circuit processing time of each of the transmitting artificial satellite 10 and the receiving artificial satellite 20 into the phase) from the phase difference obtained in processing step s112, to thereby correct the phase difference. With the correction of the phase difference, the data processing device 11 can correct the processing time difference generated in the transmitting artificial satellite 10 and the receiving artificial satellite 20. Note that the data processing device 11 may update the correction value during operation by installing in the inside thereof a feedback circuit (for example, see a fourth embodiment).

In processing step s114, the data processing device 11 uses the corrected phase difference and the difference between the transmission time of the transmission signal (radio wave 31) and the reception time of the reception signal (radio wave 32) to calculate the relative distance between the transmitting artificial satellite 10 and the receiving artificial satellite 20.

The artificial satellite system and the method for measuring the distance between the artificial satellites according to the present embodiment include the configurations described above and can measure the relative distances among the multiple artificial satellites without time synchronization. Further, the artificial satellite system and the method for measuring the distance between the artificial satellites according to the present embodiment can simultaneously measure the relative distances between one artificial satellite and multiple artificial satellites.

### Second Embodiment

A description will be made about an artificial satellite system and a method for measuring the distance between artificial satellites, according to a second embodiment of the present invention. Regarding the present embodiment, a description will hereinafter be made mainly about points different from the first embodiment.

In the present embodiment, a transmitting artificial satellite 10 adjusts speed and position of the artificial satellite using a frequency shift (Doppler shift) of a reception signal (radio wave 32) for a transmission signal (radio wave 31), which is caused by the Doppler effect due to a relative speed between the transmitting artificial satellite 10 and a receiving artificial satellite 20. In the present embodiment, the speed of the artificial satellite is adjusted, thereby to make it possible to keep the relative distance between the artificial satellites and make the relative position between the artificial satellites constant.

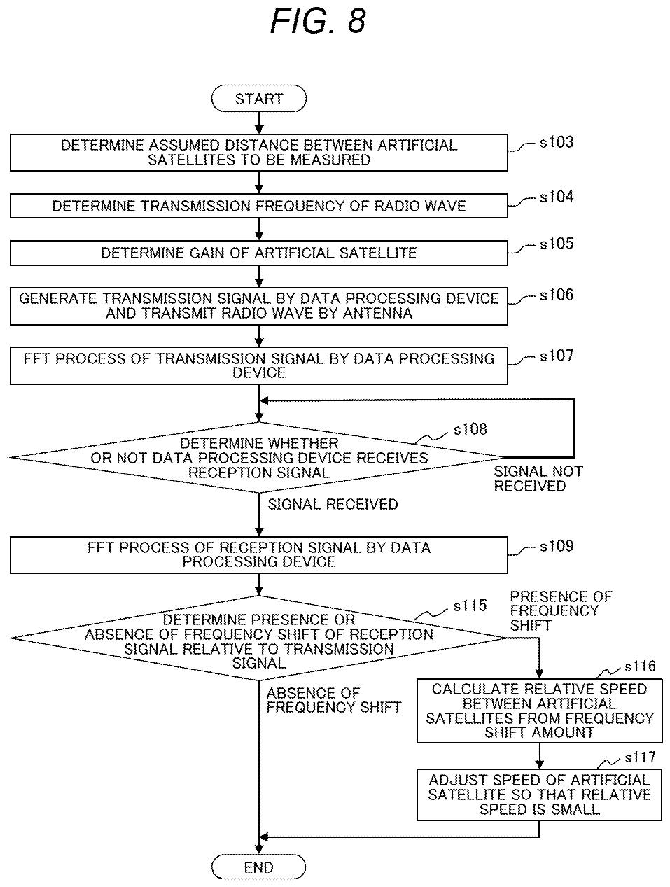

FIG. 8 is a diagram showing an example of a flowchart of sequence control to control the speed of the artificial satellite. The flowchart shown in FIG. 8 is executed by the transmitting artificial satellite 10. Processing step s103 to processing step s109 in FIG. 8 are the same as those in the first embodiment.

In processing step s115, the data processing device 11 of the transmitting artificial satellite 10 compares the results of frequency analysis by fast Fourier Transform (FFT) processing of the transmission signal and the reception signal to determine whether there is a frequency shift of the reception signal for the transmission signal. When the frequency shift is present, the data processing device 11 determines a frequency shift amount and executes processing in processing step s116.

In processing step s116, the data processing device 11 calculates a relative speed v of the receiving artificial satellite 20 to the transmitting artificial satellite 10 from the frequency shift amount determined in processing step s115 using an equation (17).

$$v = c \sqrt{{( \frac{{f}_{r 1} - {f}_{t 1}}{{f}_{r 1} + {f}_{t1}} )}^{2} + {( \frac{{f}_{r 2} - {f}_{t 2}}{{f}_{r 2} + {f}_{t 2}} )}^{2}} \qquad ( 17 )$$

In the equation (17), fₜ₁ and fₜ₂ each represent the frequency of the signal (transmission signal) which is transmitted by the transmitting artificial satellite 10, and fᵣ₁ and fᵣ₂ each represent the frequency of the signal (reception signal) which is received by the transmitting artificial satellite 10.

In processing step s117, the data processing device 11 adjusts the speed and attitude of the transmitting artificial satellite 10 so that the relative speed v determined in processing step s116 becomes small. The data processing device 11 is capable of adjusting the speed and attitude of the transmitting artificial satellite 10 using the propulsive mechanism 17 (FIG. 2) such as the thruster or the electric propulsion device. The data processing device 11 is capable of adjusting the position of the transmitting artificial satellite 10 by adjusting the speed and attitude of the transmitting artificial satellite 10.

In the present embodiment, the speed of the artificial satellite can be adjusted to keep the relative distance and position between the artificial satellites constant, and the shape of the distribution of multiple artificial satellites is maintained.

### Third Embodiment

A description will be made about an artificial satellite system and a method for measuring the distance between artificial satellites, according to a third embodiment of the present invention. Regarding the present embodiment, a description will hereinafter be made mainly about points different from the first embodiment.

In the present embodiment, the relative position (relative distance) between the transmitting artificial satellite 10 and the ground station 3 is measured to thereby measure the absolute position of the artificial satellite based on the position of the ground station 3.

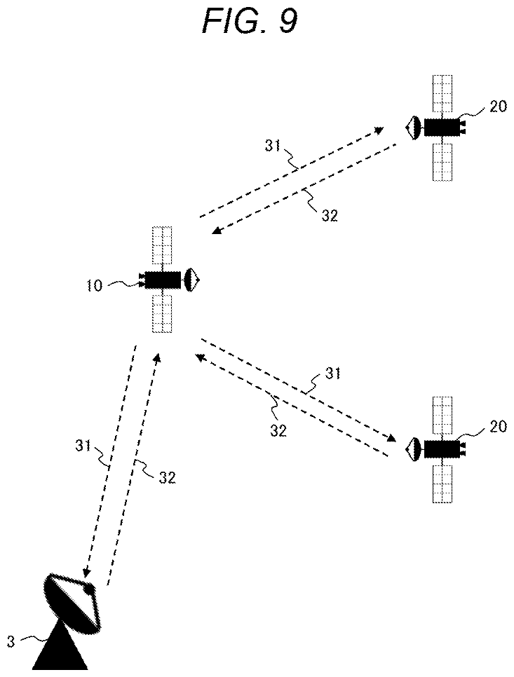

FIG. 9 is a diagram showing an example of a configuration for measuring the absolute position of the artificial satellite in the present embodiment. The transmitting artificial satellite 10 includes a plurality of antennas 13 (FIG. 2) each of which receives a reception signal (radio wave 32), and measures the relative distances to a plurality of receiving artificial satellites 20 by using the data processing device 11. The ground station 3 is installed on the ground. The transmitting artificial satellite 10 is capable of receiving radio waves transmitted from the ground station 3 by the multiple antennas 13 and measuring the relative distances to the ground station 3 by using the data processing device 11.

The data processing device 11 of the transmitting artificial satellite 10 determines the relative positions between the transmitting artificial satellite 10 and the multiple receiving artificial satellites 20 in accordance with the principle of triangulation using the relative distances between the transmitting artificial satellite 10 and the multiple receiving artificial satellites 20. Further, the data processing device 11 determines the relative position between the transmitting artificial satellite 10 and the ground station 3 in accordance with the principle of triangulation using the plural relative distances between the transmitting artificial satellite 10 and the ground station 3, which have been obtained by the plural antennas 13.

The ground station 3 is installed on the ground and is capable of measuring the absolute position. The data processing device 11 of the transmitting artificial satellite 10 can acquire the absolute position of the ground station 3 and determine the absolute position of the transmitting artificial satellite 10 from the relative position between the transmitting artificial satellite 10 and the ground station 3, on the basis of the absolute position. Then, the data processing device 11 is capable of determining the absolute position of the receiving artificial satellite 20 from the absolute position of the transmitting artificial satellite 10 and the relative position between the transmitting artificial satellite 10 and each receiving artificial satellite 20.

In the present embodiment, the absolute positions of the transmitting artificial satellite 10 and the multiple receiving artificial satellites 20 can be measured in the manner described above.

### Fourth Embodiment

A description will be made about an artificial satellite system and a method for measuring a distance between artificial satellites, according to a fourth embodiment of the present invention. Regarding the present embodiment, a description will hereinafter be made mainly about points different from the first embodiment.

In the present embodiment, software defined radios 12 and 22 of a transmitting artificial satellite 10 and a receiving artificial satellite 20 each include a feedback circuit and correct an error (ϕ₁, ϕ₂ₐ, ϕ_{2b}) in the initial phase of the local oscillator 127 using a referenced signal.

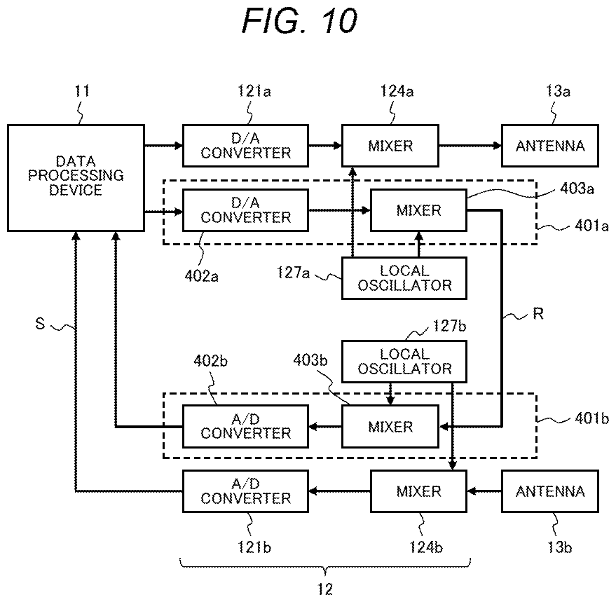

FIG. 10 is a block diagram showing an example of a schematic configuration of the software defined radio 12 in the present embodiment. The software defined radio 12 of the transmitting artificial satellite 10 includes feedback circuits 401a and 401b. Although not shown in the drawing, the software defined radio 22 of the receiving artificial satellite 20 also include similar feedback circuits. A description will hereinafter be made about the transmitting artificial satellite 10.

In the present embodiment, a local oscillator 127a used at the time of signal transmission, and a local oscillator 127b used at the time of signal reception are assumed to be different from each other in the software defined radio 12. The local oscillator 127a is used to convert the frequency of an analog signal when transmitting a signal by the antenna 13a. The local oscillator 127b is used to convert the frequency of an analog signal received by the antenna 13b.

The feedback circuit 401a includes a D/A converter 402a and a mixer 403a. The feedback circuit 401b includes an A/D converter 402b and a mixer 403b.

The data processing device 11 transmits a digital signal (reference signal R) to the feedback circuit 401a. The reference signal R is a reference signal for measuring and correcting the phase difference between the local oscillators 127a and 127b. Any signal can be used for the reference signal R.

The feedback circuit 401a converts the digital signal (reference signal R) received from the data processing device 11 into an analog signal by the D/A converter 402a. Then, the feedback circuit 401a performs frequency conversion on the analog signal using the signal from the local oscillator 127a in the mixer 403a and transmits the reference signal R subjected to the frequency conversion to the feedback circuit 401b.

The feedback circuit 401b receives the reference signal R from the feedback circuit 401a and performs frequency conversion on the reference signal R using the signal from the local oscillator 127b in the mixer 403b. Then, the feedback circuit 401b converts the reference signal R into a digital signal by the A/D converter 402b.

The data processing device 11 receives the reference signal R from the feedback circuit 401b. Then, the data processing device 11 determines the phase difference between the digital signal transmitted to the feedback circuit 401a and the digital signal received from the feedback circuit 401b, that is, the difference between the phase of the transmitted reference signal R and the phase of the received reference signal R. This phase difference corresponds to the phase difference between the two local oscillators 127a and 127b, and it becomes the factor of an error when measuring the relative distance between the artificial satellites.

Therefore, the data processing device 11 determines the phase difference using the reference signal R and subtracts the phase difference (the phase difference between the transmitted reference signal R and the received reference signal R) from the phase obtained from a reception signal S which is received by the data processing device 11, to thereby correct the phase difference between the local oscillators 127a and 127b.

In the present embodiment, when transmitting the signal and receiving the signal, the same local oscillator are not used and different local oscillators are used, it is possible to correct the phase difference between the two local oscillators by including the feedback circuits 401a and 401b to use the reference signal R.

### Fifth Embodiment

A description will be made about an artificial satellite system and a method for measuring the distance between artificial satellites, according to a fifth embodiment of the present invention. Regarding the present embodiment, a description will hereinafter be made mainly about points different from the first embodiment.

In the present embodiment, the shape (shape of distribution of multiple artificial satellites) of an artificial satellite group configured of a plurality of artificial satellites is estimated.

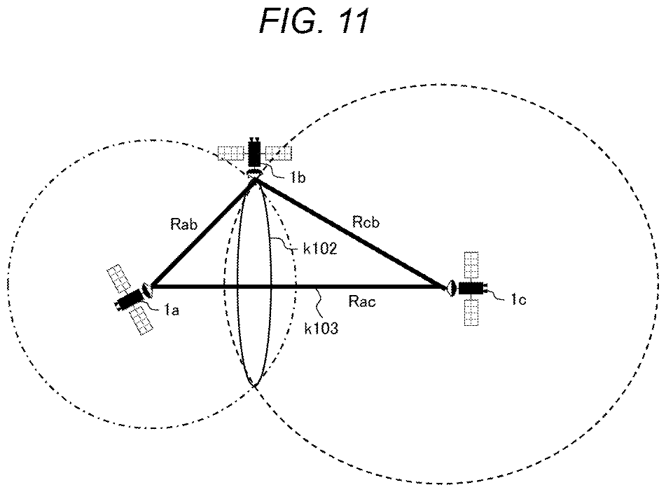

FIG. 11 is a diagram showing an example of an artificial satellite group comprised of a plurality of artificial satellites. To make the description easier to understand, FIG. 11 shows an artificial satellite group comprised of three artificial satellites 1a, 1b, and 1c as an example. However, the artificial satellite group can have two or four or more artificial satellites.

Each of the artificial satellites 1a, 1b, and 1c has the same configuration as the transmitting artificial satellite 10 (that is, it has the same configuration as the receiving artificial satellite 20) and can switch between the operation as the transmitting artificial satellite 10 and the operation as the receiving artificial satellite 20. In the present embodiment, first, the artificial satellite 1a is used as a reference, and the artificial satellite 1a measures the resistance distance to each of the artificial satellites 1b and 1c. Next, the artificial satellite 1c is used as a reference, and the artificial satellite 1c measures the relative distance to the artificial satellite 1b.

From these measurement results, the positions of the artificial satellites 1a, 1b, and 1c are represented by an equation (18) in an orthogonal coordinate system arbitrarily determined in advance.

$$[ \begin{matrix}{( {x}_{b} - {x}_{a} )}^{2} + {( {y}_{b} - {y}_{a} )}^{2} + {( {z}_{b} - {z}_{a} )}^{2} \\ {( {x}_{c} - {x}_{a} )}^{2} + {( {y}_{c} - {y}_{a} )}^{2} + {( {z}_{c} - {z}_{a} )}^{2} \\ {( {x}_{b} - {x}_{c} )}^{2} + {( {y}_{b} - {y}_{c} )}^{2} + {( {z}_{b} - {z}_{c} )}^{2}\end{matrix} ] = [ \begin{matrix}{R}_{ab}^{2} \\ {R}_{a c}^{2} \\ {R}_{cb}^{2}\end{matrix} ] \qquad ( 18 )$$

In the equation (18), (xₐ, yₐ, zₐ) represents the position of the artificial satellite 1a, (x_{b}, y_{b}, z_{b}) represents the position of the artificial satellite 1b, and (x_{c}, y_{c}, z_{c}) represents the position of the artificial satellite 1c. Further, R_{ab} represents the relative distance between the artificial satellite 1a and the artificial satellite 1b, R_{ac} represents the relative distance between the artificial satellite 1a and the artificial satellite 1c, and R_{cb} represents the relative distance between the artificial satellite 1c and the artificial satellite 1b.

Next, assuming that in order to estimate the shape of the artificial satellite group, the artificial satellite 1a is used as a reference point, and the line connecting the artificial satellite 1a and the artificial satellite 1c is a reference line k103, the positions of the artificial satellite 1a and the artificial satellite 1c are represented by an equation (19).

$$[ \begin{matrix}( {x}_{a} , {y}_{a} , {z}_{a} ) \\ ( {x}_{c} , {y}_{c} , {z}_{c} )\end{matrix} ] = [ \begin{matrix}( 0 , 0 , 0 ) \\ ( 0 , 0 , {R}_{a c} )\end{matrix} ] \qquad ( 19 )$$

Using the equation (18) and the equation (19), it can be seen that the position of the artificial satellite 1b follows an equation (20).

$${x}_{b}^{2} + {y}_{b}^{2} = {R}^{2} \qquad ( 20 )$$

$$where$$

$${R}^{2} = {R}_{a b}^{2} - {z}_{b}^{2} ,$$

$${z}_{b} = \frac{1}{2 {R}_{a c}} ( {R}_{a b}^{2} - {R}_{c b}^{2} - {R}_{a c}^{2} )$$

It can be seen from the equation (20) that the artificial satellite 1b is positioned on a circle k102 of a radius R. Note that FIG. 11 is drawn as a circle (ellipse) seen from the diagonal direction of the circle k102.

Further, it can be seen that the shape of the artificial satellite group comprised of the artificial satellites 1a, 1b, and 1c is a specific triangle whose lengths of three sides are relative distances R_{ab}, R_{ac}, and R_{cb}.

In the way described above, the data processing devices 11 of the artificial satellites 1a, 1b, and 1c determine the mutual relative distances R_{ab}, R_{ac}, and R_{cb} in the artificial satellites 1a, 1b, and 1c and determine the positions of the artificial satellites 1a, 1b, and 1c from these relative distances, thereby making it possible to estimate the shape of the artificial satellite group.

Incidentally, when the arrival angle of the reception signal (radio wave 32) and the like are also measured by increasing the number of antennas for the artificial satellites 1a to 1c, etc., the data processing device 11 can determine the shape of the artificial satellite group uniquely.

It should be noted that the present invention is not limited to the foregoing embodiments, and the foregoing embodiments may be variously modified. The foregoing embodiments have been described in detail, for example, in order to facilitate the understanding of the present invention. The present invention is not limited to embodiments including all the above-described elements. Some elements of an embodiment may be replaced by the elements of another embodiment. Further, elements of an embodiment may be added to another embodiment. Furthermore, some elements of each embodiment may be deleted, subjected to the addition of other elements, or replaced by other elements.

### REFERENCE SIGNS LIST

1a to 1d: artificial satellite, 2a, 2b: artificial satellite, 3: ground station, 4: artificial satellite system, 10: transmitting artificial satellite, 11, 11a, 11b: data processing device, 12, 12a, 12b: software defined radio, 13, 13a, 13b: antenna, 17: propulsive mechanism, 18: control device, 19: sensor, 20, 20a, 20b: receiving artificial satellite, 21, 21a, 21b: data processing device, 22, 22a, 22b: software defined radio, 23, 23a, 23b: antenna, 27: propulsive mechanism, 28: control device, 29: sensor, 31, 32: radio wave, 50, 51: processing to measure relative distance, 121a: D/A converter, 121b: A/D converter, 122a, 122b: filter, 123a, 123b: amplifier, 124a, 124b: mixer, 125a, 125b: amplifier, 126a, 126b: filter, 127, 127a, 127b: local oscillator, 401a, 401b: feedback circuit, 402a: D/A converter, 402b: A/D converter, 403a, 403b: mixer, c101: measurement-start command, k102: circle, k103: reference line, R: reference signal, S: reception signal, s101: filter function, s102: frequency conversion function

What is claimed is:

1. An artificial satellite system comprising:
a plurality of artificial satellites including at least a first artificial satellite and a second artificial satellite,
wherein each of the artificial satellites includes a data processing device, a software defined radio, and an antenna,
wherein the antenna of the first artificial satellite transmits a radio wave to the second artificial satellite as a transmission signal,
wherein the antenna of the second artificial satellite receives the transmission signal,
wherein the software defined radio of the second artificial satellite generates a signal having a same frequency and phase as the transmission signal,
wherein the antenna of the second artificial satellite transmits a radio wave of the signal generated by the software defined radio of the second artificial satellite to the first artificial satellite,
wherein the antenna of the first artificial satellite receives the radio wave transmitted by the second artificial satellite as a reception signal, and
wherein the data processing device of the first artificial satellite determines a relative distance between the first artificial satellite and the second artificial satellite by using a difference between a transmission time of the transmission signal and a reception time of the reception signal and a phase difference between the transmission signal and the reception signal.

2. The artificial satellite system according to claim 1,
wherein the software defined radio of the second artificial satellite includes a frequency filter function of passing a signal that is of the transmission signal received by the second artificial satellite and in a frequency band assigned to the second artificial satellite, and generates a signal having a same frequency and phase as the signal passed by the frequency filter function, and
wherein the antenna of the second artificial satellite transmits a radio wave of the signal generated by the software defined radio of the second artificial satellite to the first artificial satellite.

3. The artificial satellite system according to claim 1,
wherein the first artificial satellite includes a propulsive mechanism configured to drive the first artificial satellite, and
wherein the data processing device of the first artificial satellite adjusts a speed and a position of the first artificial satellite using the propulsive mechanism based on a frequency shift amount of the reception signal to the transmission signal.

4. The artificial satellite system according to claim 1,
wherein the data processing device of the first artificial satellite determines a relative position between the first artificial satellite and a ground station on a ground, and determines positions that are of the first artificial satellite and the second artificial satellite and based on the position of the ground station, by using the relative distance between the first artificial satellite and the second artificial satellite and the relative position.

5. The artificial satellite system according to claim 1,
wherein the software defined radio includes a local oscillator which performs frequency conversion processing in generating the transmission signal and frequency conversion processing on the reception signal.

6. The artificial satellite system according to claim 1,
wherein the software defined radio includes:
a first local oscillator which performs frequency conversion processing in generating the transmission signal,
a second local oscillator which performs frequency conversion processing on the reception signal,
a first feedback circuit which performs frequency conversion processing on a reference signal received from the data processing device by using the first local oscillator, and
a second feedback circuit which performs frequency conversion processing on the reference signal received from the first feedback circuit by using the second local oscillator, and
wherein the data processing device determines a phase difference between a phase of the reference signal transmitted to the first feedback circuit and a phase of the reference signal received from the second feedback circuit, and corrects a phase difference between the first local oscillator and the second local oscillator by using the determined phase difference.

7. The artificial satellite system according to claim 1,
wherein the software defined radio includes an amplifier which amplifies an amplitude of a signal, and
wherein a gain of the amplifier is determined based on a distance assumed as the relative distance between the first artificial satellite and the second artificial satellite.

8. The artificial satellite system according to claim 1,
wherein a frequency of the transmission signal transmitted by the first artificial satellite is determined based on a distance assumed as the relative distance between the first artificial satellite and the second artificial satellite.

9. The artificial satellite system according to claim 1,
wherein the data processing devices of the artificial satellites determine mutual relative positions of the artificial satellites from relative distances between the artificial satellites.

10. The artificial satellite system according to claim 1,
wherein the first artificial satellite and the second artificial satellite have a same configuration with each other and are configured to be capable of transmitting the transmission signal and receiving the transmission signal.

11. A method for measuring a distance between artificial satellites, comprising the steps of:
allowing a first artificial satellite to transmit a radio wave to a second artificial satellite as a transmission signal;
allowing the second artificial satellite to receive the transmission signal;
allowing the second artificial satellite to generate a signal having a same frequency and phase as the transmission signal;
allowing the second artificial satellite to transmit a radio wave of the signal generated by the second artificial satellite to the first artificial satellite;
allowing the first artificial satellite to receive the radio wave transmitted by the second artificial satellite as a reception signal; and
allowing the first artificial satellite to determine a relative distance between the first artificial satellite and the second artificial satellite by using a difference between a transmission time of the transmission signal and a reception time of the reception signal and a phase difference between the transmission signal and the reception signal.
